(19) United States
(12) Patent Application Publication
(10) Pub. No.: US 2013/0322796 A1
(43) Pub. Date: Dec. 5, 2013

(54) BUSHING ASSEMBLY

(71) Applicant: Robert J. Taylor, Shelby Township, MI (US)

(72) Inventor: Robert J. Taylor, Shelby Township, MI (US)

(21) Appl. No.: 13/935,984

(22) Filed: Jul. 5, 2013

Related U.S. Application Data
(63) Continuation of application No. 12/143,930, filed on Jun. 23, 2008.
(60) Provisional application No. 60/945,812, filed on Jun. 22, 2007.

(51) Int. Cl. F16C 17/02

(52) U.S. Cl. CPC F16C 17/02
USPC 384/416

(57) ABSTRACT

A bushing assembly is disclosed and includes a bushing that can have an outer surface and an inner surface that can define an opening. The bushing can be configured to fit into a bore and receive a shaft through the opening. The bushing can include at least one flange. The flange can include at least one void. The void can be adapted to prevent an engagement torque, T, between bushing and the shaft from increasing more than twenty-five percent as an interference fit between the bushing and the bore increases. The interference fit can be quantified by a reduction in outer radius, I, by at least 0.025 mm.

### CROSS-REFERENCE TO RELATED APPLICATION(S)

This application claims priority under 35 U.S.C. §120 to and is a continuation of U.S. patent application Ser. No. 12/143,930 entitled “Bushing Assembly,” by Robert Taylor, filed Jun. 23, 2008, which claims priority to U.S. Provisional Application No. 60/945,812 filed Jun. 22, 2007, entitled “Bushing Assembly” and having named inventor Robert Taylor, both of which applications are incorporated by reference herein in their entireties.

### FIELD OF THE DISCLOSURE

The present disclosure relates generally to bushings.

### BACKGROUND

Traditionally, a mechanical bushing is a cylindrical lining designed to reduce friction and wear, or constrict and restrain motion of mechanical parts. For example, a bushing can be installed around a shaft and the shaft can rotate or slide within the bushing. A typical bushing is sized and shaped to receive a single sized shaft milled to fairly strict tolerances. If the shaft is oversized, or undersized, the bushing may not provide the proper support for the shaft and the shaft may not operate correctly.

Accordingly, there exists a need for an improved bushing and an improved bushing/shaft assembly.

### BRIEF DESCRIPTION OF THE DRAWINGS

The present disclosure may be better understood, and its numerous features and advantages made apparent to those skilled in the art by referencing the accompanying drawings.

FIG. 1 is a view of a steering column assembly;

FIG. 2 is a cross-section view of a lower mounting bracket associated with the steering column assembly;

FIG. 3 is a perspective view of a bushing assembly associated with the steering assembly;

FIG. 4 is a front plan view of the bushing assembly;

FIG. 5 is a side plan view of the bushing assembly;

FIG. 6 is a perspective view of a bushing associated with the bushing assembly;

FIG. 7 is a front plan view of the bushing;

FIG. 8 is a side plan view of the bushing;

FIG. 9 is a cross-section view of the bushing taken along line 9-9 in FIG. 7;

FIG. 10 is a perspective view of a resilient member associated with the bushing assembly; and

FIG. 11 is a graph of torque versus interference fit associated with the bushing assembly.

### DESCRIPTION OF THE PREFERRED EMBODIMENTS

A bushing assembly is disclosed and includes a bushing that can have an outer surface and an inner surface that can define an opening. The bushing can be configured to fit into a bore and receive a shaft through the opening. An engagement torque, T, between bushing and the shaft does not increase more than twenty-five percent as an interference fit between the bushing and the bore increases. The interference fit can be quantified by a reduction in outer radius, I, by at least 0.025 mm.

In another embodiment, a bushing assembly is disclosed and can include a bushing that can have a hub and at least one flange extending from the hub. Further, the bushing assembly can include a resilient member engaged with the bushing. The resilient member is disposed around the hub adjacent to the at least one flange.

In yet another embodiment, an assembly is disclosed and can include a shaft that can have an outer radius dimensional tolerance, DT, of at least plus or minus 0.025 mm. The assembly can further include a bushing assembly circumscribing the shaft. Moreover, a shaft engagement torque between the shaft and the bushing remains does not vary greater than twenty-five percent over a range of dimensions within the dimensional tolerance.

In still another embodiment, a steering column assembly is disclosed and can include a mounting bracket formed with a groove and a bushing assembly disposed within the groove. Further, the steering column assembly can include a shaft extending through the bushing assembly. The bushing assembly can provide a shaft engagement torque that can remain substantially constant as an interference fit between the bushing assembly and the groove increases.

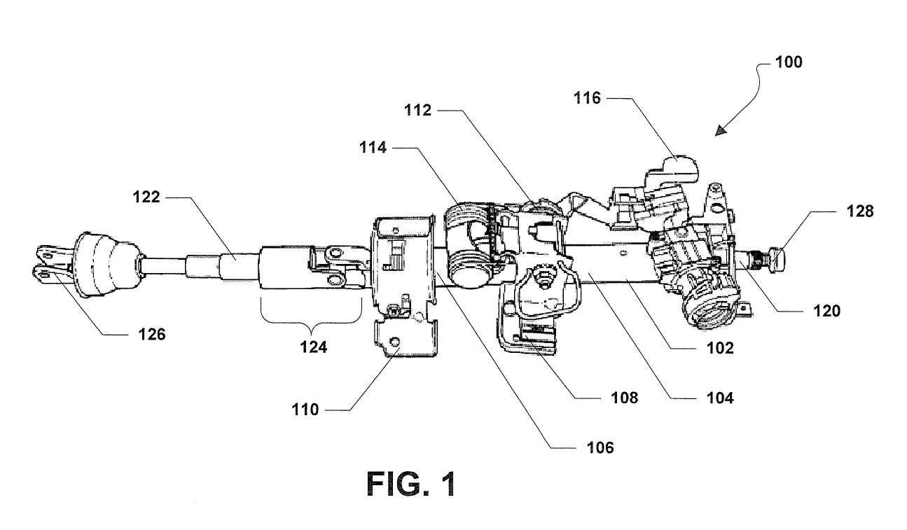

Referring initially to FIG. 1, an exemplary steering column assembly is shown and is generally designated 100. As shown, the steering column assembly can include a generally cylindrical housing 102. The housing 102 can have an upper portion 104 and a lower portion 106. Further, the housing 102 can include an upper mounting bracket 108 and a lower mounting bracket 110. Also, the housing 102 can include a hinge 112 formed in the upper mounting bracket 108 between the upper portion 104 and the lower portion 106. The hinge 112 can allow the steering column assembly to be “tilted,” i.e., bent for driver comfort. The housing 102 can also include a torsion spring 114 adjacent to the hinge 112. The torsion spring 114 can support the upper portion 104 of the housing 102 during rotation of the upper portion 104 of the housing 102 relative to the lower portion 106 of the housing 102 when the steering column assembly is tilted. The steering column assembly 100 can also include a lever 116 that can be toggled in order to release, or unlock, the hinge 112 and allow the steering column assembly 100 to be tilted.

FIG. 1 illustrates that the steering column assembly 100 can include an upper shaft 120 that can extend into the upper portion 104 of the housing 102. Moreover, the steering column assembly 100 can include an intermediate shaft 122 that can extend into the lower portion 106 of the housing 102. The intermediate shaft 122 can be coupled to the upper shaft 120 at, or near, the hinge 112 interface between the upper portion 104 of the housing 102 and the lower portion 106 of the housing 102. The intermediate shaft 122 can be coupled to the upper shaft 120 by a universal (U) joint (not shown).

As shown in FIG. 1, the intermediate shaft 122 can include a flexible joint 124. The flexible joint 124 can allow the intermediate shaft 122 to be bent and to expand linearly due to dynamic changes in the geometry of the drive train in which the steering column assembly 100 is installed. FIG. 1 also shows that the intermediate shaft 122 can include an intermediate shaft coupler 126. The intermediate shaft coupler 126 can allow the steering column assembly 100 to be connected to a lower shaft (not shown) that extends from a steering assembly, e.g., a rack-and-pinion assembly (not shown). FIG. 1 also shows that the upper shaft 120 can be formed with a splined end 128 that is configured to receive a steering wheel assembly (not shown) after the steering column assembly 100 is installed within a vehicle.

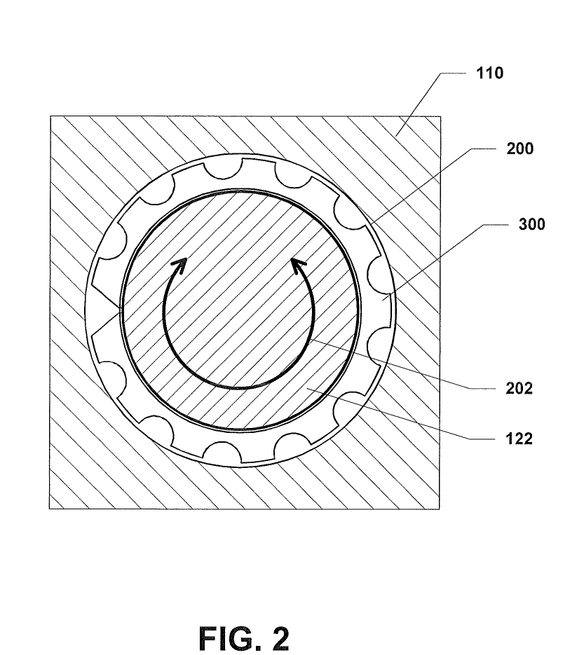

Referring to FIG. 2, a portion of the lower mounting bracket 110 is shown in cross-section. The lower mounting bracket 110 can be formed with a groove 200. Further, as shown, a bushing assembly 300 can be installed within the groove 200. The intermediate shaft 122 can extend through the bushing assembly 300. In a particular embodiment, the intermediate shaft 122 can rotate relative to the bushing assembly 202, as indicated by arc 202. The bushing assembly 300 can engage the groove 200 in an interference fit and remain stationary within the groove 200.

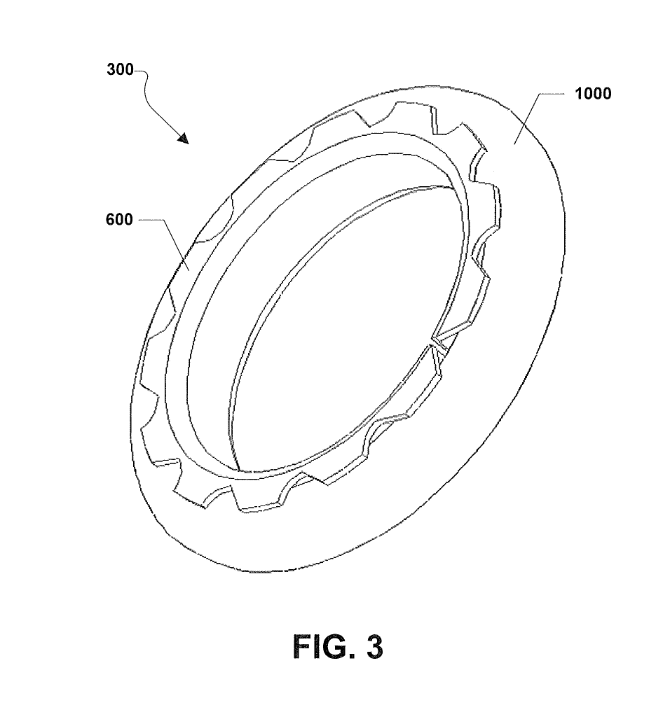

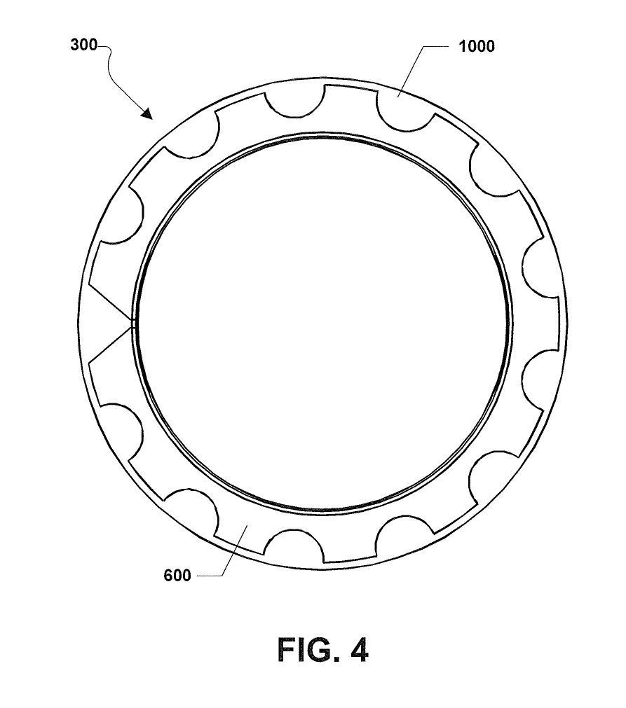

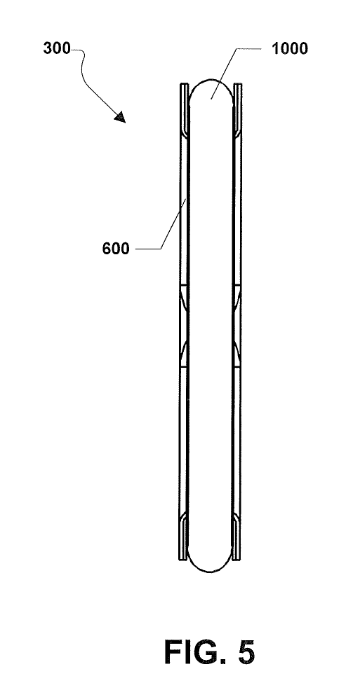

FIG. 3 through FIG. 10 illustrate the details of the bushing assembly 300. As indicated in FIG. 3 through FIG. 5, the bushing assembly 300 can include a bushing 600 and a resilient member 1000 installed around the bushing 600. In a particular embodiment, the resilient member 1000 circumscribes the bushing 600.

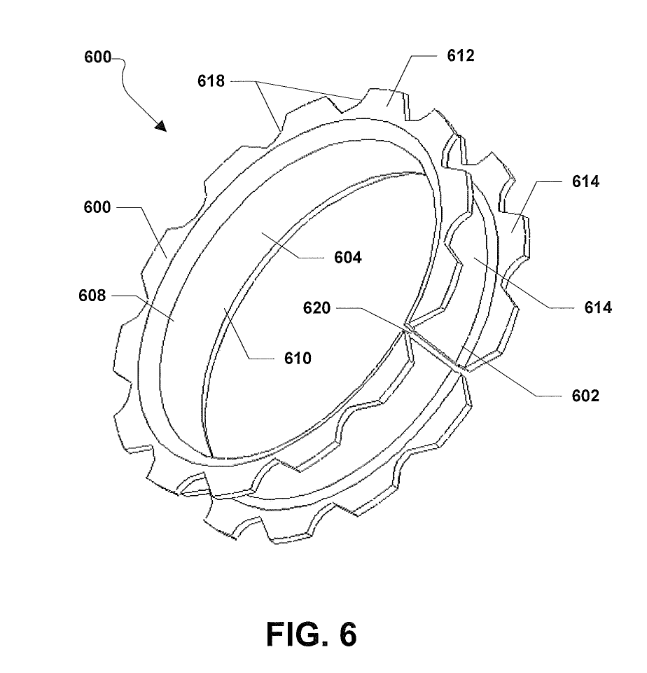

FIG. 6 through FIG. 9 illustrate the details concerning the construction of the bushing 600. As shown, the bushing 600 can include a hub 602. The hub 602 can include an inner surface 604 and an outer surface 606. The inner surface 604 can define an opening through which a shaft can be inserted. Moreover, the hub 602 can include a first end 608 and a second end 610. A first flange 612 can extend from the hub 602. In particular, the first flange 612 can extend radially outward from the hub 602, e.g., from the outer surface 606 of the hub 602 at or near the first end 608 of the hub 602. The bushing 600 can also include a second flange 614 extending from the hub 602. In particular, the second flange 614 can extend radially outward from the hub 602, e.g., from the outer surface 606 of the hub 602 at or near the second end 610 of the hub 602, opposite the first flange 612.

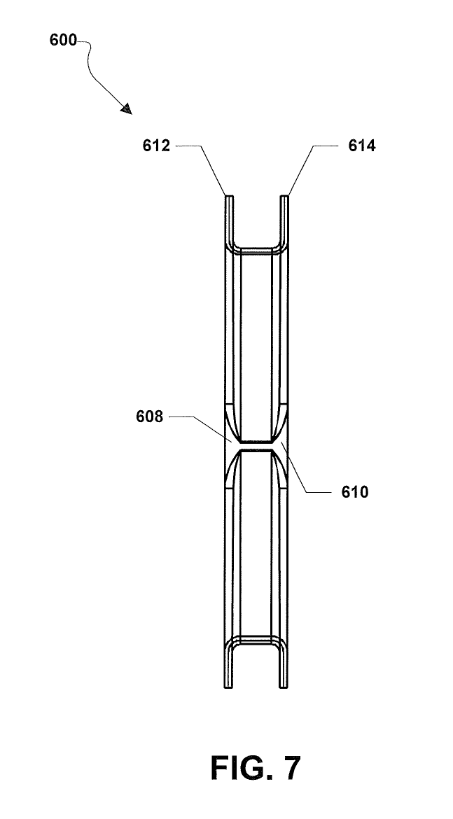

As shown in FIG. 6 and FIG. 7, the bushing 600 can include a generally U-shaped pocket 616 that is bound the first flange 612, the hub 602, and the second flange 614. In a particular embodiment, as shown in FIG. 3 through FIG. 5, the resilient member 1000 can fit into the pocket 616 formed by the bushing 600. Further, the resilient member 1000 can circumscribe the hub 602 of the bushing 600.

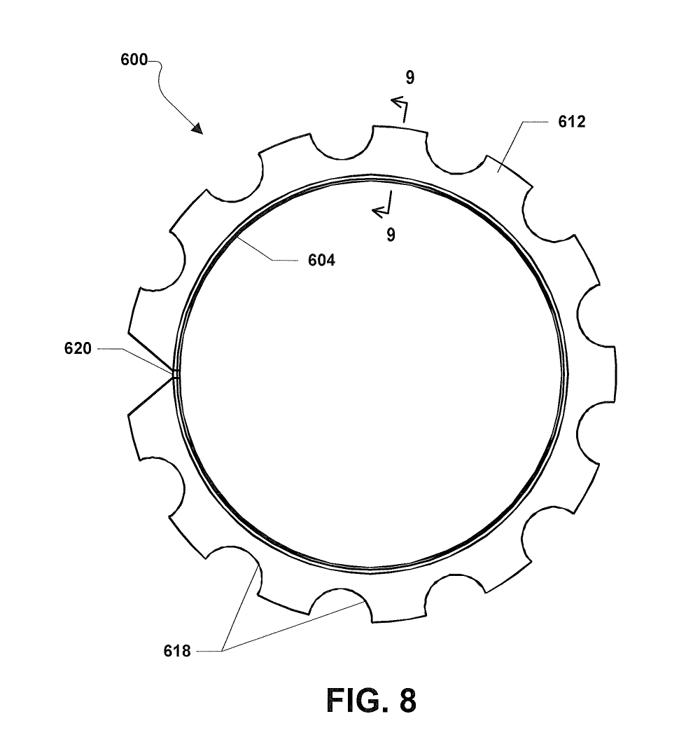

FIG. 6 and FIG. 8 show that the bushing 600 can be formed with a plurality of voids 618. Specifically, the bushing 600 can include a plurality of voids 618 formed along the perimeter of the first flange 612 and along the perimeter of the second flange 614. Each void 618 can be an arcuate cutout. More specifically, each void can be a semi-circular cutout. The bushing 600 can also include a split 620 so that the bushing 600 does not form a complete circle. In a particular embodiment, the voids 618 and the split 620 can allow the bushing 600 to expand radially outward when a shaft having a larger external radius than the internal radius of the bushing 600 is installed within the bushing assembly 300, as shown in FIG. 2.

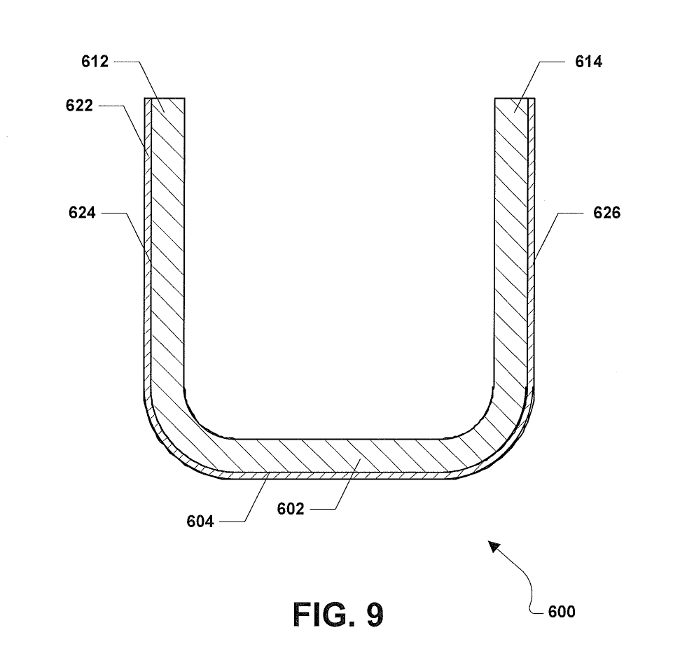

Referring now to FIG. 9, the bushing 600 can include a low friction layer 622 that can at least partially cover the bushing 600. In a particular embodiment, the low friction layer 622 can extend along an outer surface 624 of the first flange 612, along the inner surface 604 of the hub, and along an outer surface 626 of the second flange 614. The low friction layer 622 can be at least 0.05 millimeters (mm) thick. In another embodiment, the low friction layer 622 can be at least 0.10 mm thick. In yet another embodiment, the low friction layer 622 can be at least 0.15 mm thick. In still another embodiment, the low friction layer 622 can be at least 0.20 mm thick. In another embodiment, the low friction layer 622 can be at least 0.25 mm thick. In yet still another embodiment, the low friction layer 622 can be at least 0.30 mm thick. In another embodiment, the low friction layer 622 can be at least 0.35 mm thick. In yet another embodiment, the low friction layer 622 can be at least 0.40 mm thick. In still another embodiment, the low friction layer 622 can be at least 0.45 mm thick. In yet still another embodiment, the low friction layer 622 can be at least 0.50 mm thick. In another embodiment, the low friction layer 622 is not greater than 1.0 mm thick.

In a particular embodiment, the hub 602 and the flanges 612, 614 of the bushing 600 can be made from metal. For example, the hub 602 and the flanges 612, 614 can be made from steel. In particular, the steel can be a mild steel, e.g., AISI 1008 steel.

In a particular embodiment, the low friction layer 622 can be made from a low friction polymer. The low friction polymer can be a fluoropolymer. An exemplary fluoropolymer includes a polymer formed from a fluorine substituted olefin monomer or a polymer including at least one monomer selected from the group consisting of vinylidene fluoride, vinylfluoride, tetrafluoroethylene, hexafluoropropylene, trifluoroethylene, chlorotrifluoroethylele, or a mixture of such fluorinated monomers.

An exemplary fluoropolymer may include a polymer, a polymer blend or a copolymer including one or more of the above monomers, such as, for example, fluorinated ethylene propylene (FEP), ethylene-tretrafluoroethylene (ETFE), poly tetrafluoroethylene-perfluoropropylvinylether (PFA), poly tetrafluoroethylene-perfluoromethylvinylether (MFA), polytetrafluoroethylene (PTFE), polyvinylidene fluoride (PVDF), ethylene chlorotrifluoroethylene (ECTFE), polychlorotrifluoroethylene (PCTFE), or tetrafluoroethylene-hexafluoropropylene-vinylidene fluoride (THV).

In particular, the fluoropolymer may be polytetrafluoroethylene (PTFE), such as a modified PTFE. In an example, the modified PTFE is a copolymer of tetrafluoroethylene and a vinyl ether, such as perfluoropropylvinylether (PPVE). In an embodiment, the modified PTFE includes at least about 0.01 wt % perfluoropropylvinylether (PPVE). In another example, the modified PTFE includes not greater than about 5.0 wt % PPVE, such as not greater than about 3.0 wt % or not greater than about 1.5 wt % PPVE. While particular embodiments of modified PTFE that include PPVE are melt processable, a particularly useful modified PTFE includes a small amount of PPVE such that the modified PTFE is not melt processable and instead is typically solution deposited and sintered. Particular examples of modified PTFE are commercially available, such as TFM1700 available from Dyneon, Teflon® NXT available from DuPont®, and M1-11 available from Daikon. The low friction layer 622 can be affixed to the metal substrate using an adhesive. For example, the adhesive an be an ethylene tetrafluoroethylene (ETFE) glue.

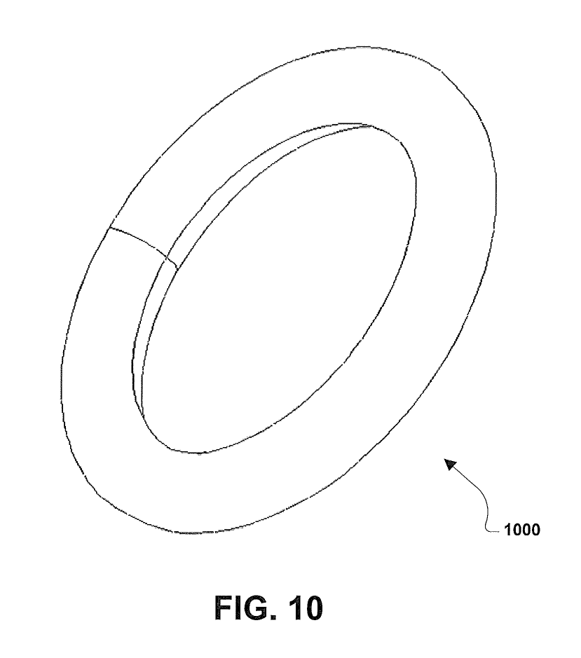

FIG. 10 illustrates the resilient member 1000. In a particular embodiment, the resilient member 1000 is a toroid made from a resilient material. For example, the resilient member 1000 is an O-ring made from neoprene, polyurethane, or a combination thereof. Further, the O-ring can have a cross-section that is generally circular. Alternatively, the O-ring can have a cross-section that is generally elliptical. In another embodiment, the resilient member 1000 can be a generally band-shaped resilient member. Further, the band-shaped resilient member can have a cross-section that is square. Alternatively, the band-shaped resilient member can have a cross-section that is rectangular. Still in another embodiment, the band-shaped resilient member can have a cross-section that is trapezoidal.

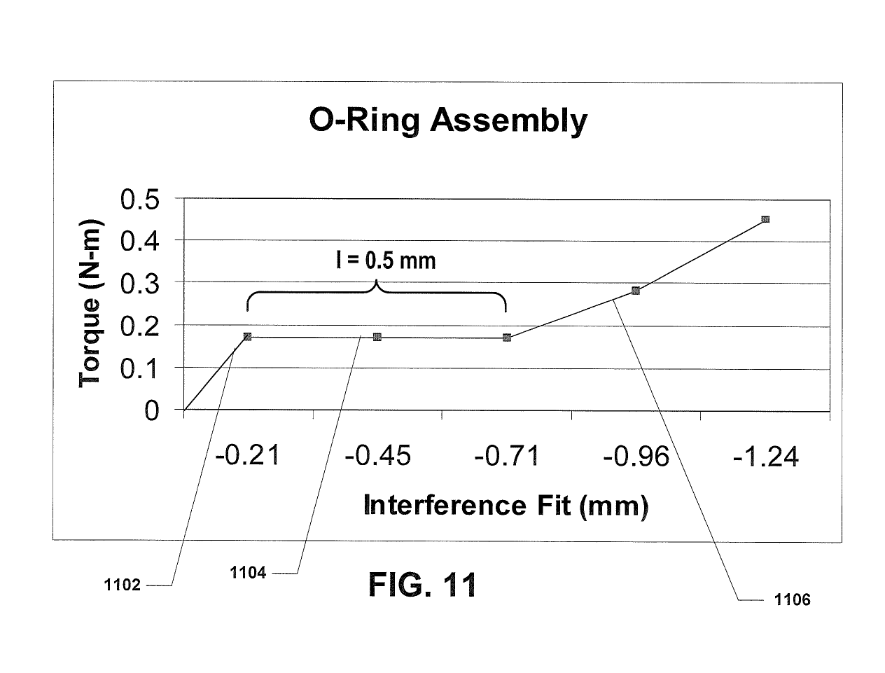

FIG. 11 is a graph that illustrates torque plotted versus interference fit. Specifically, the graph illustrates the shaft engagement torque, T, provided at the interface between a shaft inserted into a bushing assembly and the inner surface of the bushing assembly. T is plotted versus an interference fit between the bushing assembly and a bore in which the bushing assembly is installed.

During testing, a shaft was placed inside the bushing assembly and the bushing assembly was placed in a split collar, e.g., a clamshell shaped collar. The collar was repeatedly tightened in order to increase the interference fit of the bushing assembly and the inner bore of the collar. Further, the shaft was rotated within the bushing assembly as the interference fit increased and the torque on the shaft was measured at the outer radius of the shaft.

As shown in FIG. 11, the graph includes a first portion 1102 in which T increases from zero N-m, when no interference fit exists, and to approximately 0.175 N-m when the inner radius of the collar is reduced by −0.21 mm and an interference fit is established between the inner radius of the collar and the outer radius of the bushing assembly. The graph also includes a second portion 1104 in which T remains substantially constant (i.e., T=0% increase) as the outer radius is reduced from −0.21 to −0.45 mm and further to −0.71 mm. Thereafter, the graph includes a third portion 1106 in which T increases as the interference fit is increased by reducing the inner radius of the collar. When the inner radius of the collar is reduced to approximately −0.81 mm, T increases approximately twenty-five percent (25%) from the constant value of T between 0.21 mm and 0.71 mm.

Accordingly, T remains substantially constant as the interference fit between the bushing assembly and the bore increases. The interference fit, I, can be quantified by a reduction in outer radius of the bushing assembly. For example, I is less than or equal to 0.025 mm. In another embodiment, I is less than or equal to 0.05 mm. In yet another embodiment, I is less than or equal to 0.1 mm. In another embodiment, I is less than or equal to 0.15 mm. In still another embodiment, I is less than or equal to 0.2 mm. In yet still another embodiment, I is less than or equal to 0.25 mm. In another embodiment, I is less than or equal to 0.3 mm. In yet another embodiment, I is less than or equal to 0.35 mm. In still yet another embodiment, I is less than or equal to 0.40 mm. In another embodiment, I is less than or equal to 0.45 mm. In another embodiment, I is less than or equal to 0.5 mm. In yet another embodiment, I is not greater than 1.0 mm.

In a particular embodiment, as the interference fit increases, an increase in T from an initial value, T₁, is less than or equal to twenty-five percent (25%). In another embodiment, the increase in T is less than or equal to twenty percent (20%). In yet another embodiment, the increase in T is less than or equal to fifteen percent (15%). In still another embodiment, the increase in T is less than or equal to ten percent (10%). In another embodiment, the increase in T is less than or equal to five percent (5%). In yet another embodiment, T remains substantially constant.

In another embodiment, the bushing assembly, once installed in a bore of constant dimension, can provide constant torque for a shaft having a radius with a dimensional tolerance, DT, of at least plus or minus 0.025 mm. In another embodiment, DT is at least plus or minus 0.05 mm. In yet another embodiment, DT is at least plus or minus 0.1 mm. In another embodiment, DT is at least plus or minus 0.15 mm. In still another embodiment, DT is at least plus or minus 0.2 mm. In another embodiment, DT is at least plus or minus 0.25 mm. In yet another embodiment, DT is not greater than 0.5 mm.

The bushing assembly can also provide a constant linear contact force with a shaft over the same ranges described above for the interference fits show in FIG. 11 and for the same values of DT.

Further, the low friction layer 622 can minimize friction between a shaft installed within the bushing assembly 300, as shown in FIG. 2, and the bushing 600. For example, the friction between the shaft and the low friction layer 622 is less than or equal to 1.0 N-m. Further, the friction between the shaft and the low friction layer 622 is less than or equal to 0.75 N-m. Alternatively, the friction between the shaft and the low friction layer 622 is less than or equal to 0.5 N-m. In another embodiment, the friction between the shaft and the low friction layer 622 is less than or equal to 0.4 N-m. In yet another embodiment, the friction between the shaft and the low friction layer 622 is less than or equal to 0.3 N-m. In still another embodiment, the friction between the shaft and the low friction layer 622 is less than or equal to 0.2 N-m. In another embodiment, the friction between the shaft and the low friction layer 622 is less than or equal to 0.1 N-m. In yet still another embodiment, the friction between the shaft and the low friction layer 622 is not less than 0.05 N-m.

One of more embodiments of a bushing assembly, described herein, can be installed within a housing. A shaft can be installed within the bushing assembly. The shaft can rotate within the bushing assembly or the shaft can slide within the bushing assembly. The bushing assembly can provide a constant torque or a constant sliding force at the interface of the bushing assembly and the shaft. Further, the bushing assembly can provide a constant torque or sliding force over a range of dimensional tolerances of the shaft. For example, if a particular shaft is 25.4 mm plus or minus 0.25 mm, the bushing assembly can provide constant torque over the entire range of tolerances, e.g., 25.15 mm to 25.65 mm.

Since the bushing assembly provides a constant torque over a wide range of dimensional tolerances, a particular shaft need not be manufactured to relatively strict tolerances. As such, the costs associated with manufacturing shafts used in conjunction with the bushing assemblies can be greatly reduced. Further, other dimensional variations, e.g., due to welding or machining, may not cause the engagement torque or sliding force to change from a constant value. Also, the bushing assembly can substantially mitigate any wobble due to unbalanced, or slightly deformed, shafts. Since the engagement torque or sliding force remains constant, the user experience is the same over a range of sizes or variations in shafts. In other words, a steering column including such a bushing assembly will provide the same torque at the steering wheel for steering shafts having a range of sizes within a dimensional tolerance.

Embodiments discussed herein can be used in various applications. For example, as described herein, one or more embodiments can be used in conjunction with a steering column assembly. Alternatively, one or more embodiments can be used in conjunction with a telescoping minor assembly. In such an assembly, a shaft can slide within the bushing assembly and minor variations in the shaft geometry can be mitigated by the bushing assembly, or bushing assemblies.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A bushing assembly, comprising:
a bushing having a hub including an outer surface and an inner surface defining an opening and at least one flange extending from the hub, wherein at least one void is formed along a perimeter of the flange, wherein the bushing is configured to fit into a bore and receive a shaft through the opening, and wherein the at least one void in the flange is adapted to prevent an engagement torque, T, between the bushing and the shaft from increasing more than twenty-five percent as an interference fit between the bushing and the bore increases, quantified by a reduction in outer radius of the bushing assembly, I, by at least 0.025 mm.

2. The bushing assembly of claim 1, wherein the bushing further comprises a low friction layer at least partially disposed over the inner surface of the bushing.

3. The bushing assembly of claim 2, wherein the low friction layer comprises a fluoropolymer material.

4. The bushing assembly of claim 1, wherein the bushing is formed with an axial split.

5. The bushing assembly of claim 1, wherein T does not increase more than twenty percent as the interference fit between the bushing and the bore increases.

6. The bushing assembly of claim 5, wherein T does not increase more than five percent as the interference fit increases.

7. The bushing assembly of claim 6, wherein T is constant as the interference fit increases.

8. The bushing assembly of claim 1, wherein I is less than or equal to 0.1 mm.

9. The bushing assembly of claim 1, wherein the at least one flange comprises:
a first flange extending radially outwardly from the hub;
a second flange extending radially outwardly from the hub, wherein a pocket is formed in an area bound by the hub, the first flange, and the second flange; and
a resilient member disposed within the pocket.

10. The bushing assembly of claim 9, wherein the at least one void comprises a plurality of voids formed along a perimeter of the first flange and along a perimeter of the second flange.

11. The bushing assembly of claim 10, wherein the plurality of voids are spaced apart around an entirety of the perimeter of the first flange and the second flange.

12. A bushing assembly, comprising:
a bushing having a hub and at least one flange integral with and extending from the hub, wherein the bushing is formed with an axial split, wherein at least one void is formed along a perimeter of the flange, wherein the voids are adapted to prevent an engagement torque, T, between the bushing and a shaft disposed therein from increasing more than twenty-five percent as an interference fit between the bushing and the shaft increases, quantified by a reduction in outer radius of the bushing assembly, I, by at least 0.025 mm, and wherein an inner surface of the bushing is at least partially covered by a low friction layer; and
a resilient member engaged with the bushing, wherein the resilient member is disposed around the hub adjacent to the at least one flange.

13. The bushing assembly of claim 15, wherein the at least one flange comprises a first flange extending radially from the hub and a second flange extending radially from the hub, wherein a pocket is formed in an area bound by the hub, the first flange, and the second flange.

14. The bushing assembly of claim 16, wherein the resilient member is disposed within the pocket.

15. An assembly, comprising:
a shaft having an outer radius dimensional tolerance, DT, of at least plus or minus 0.1 mm; and
a bushing assembly circumscribing the shaft, wherein the bushing assembly comprises a split bushing circumscribed by a resilient member, wherein the bushing includes a hub formed with an inner surface and at least one flange integral with and extending from the hub, wherein the flange includes at least one void formed in the perimeter of the flange and an outer surface, and wherein the at least one void is adapted to prevent a shaft engagement torque between the shaft and the bushing assembly from varying greater than twenty-five percent over a range of dimensions within the dimensional tolerance.

16. The assembly of claim 18, wherein DT is at least plus or minus 0.05 mm.

17. The assembly of claim 19, wherein DT is at least plus or minus 0.025 mm.
